(19) United States
(12) Patent Application Publication
(10) Pub. No.: US 2010/0048260 A1
(43) Pub. Date: Feb. 25, 2010

(54) MOBILE PHONE HOLDER WITH LATERAL POWER SUPPLY, ESPECIALLY FOR A MECHANICAL VEHICLE

(75) Inventor: Henryk BURY, Mielec (PL)

Correspondence Address: MATTHIAS SCHOLL, 14781 MEMORIAL DRIVE, SUITE 1319, HOUSTON, TX, 77079, US

(73) Assignee: BURY Sp z o.o., Mielec (PL)

(21) Appl. No.: 12/540,569

(22) Filed: Aug. 13, 2009

(30) Foreign Application Priority Data
Aug. 21, 2008 (EP) 08460035

(51) Int. Cl. H04M 1/00

(52) U.S. Cl. 455/575.1

(57) ABSTRACT

A holder for a mobile phone, containing at least a main base; a cover with a holder cavity; a slide comprising a slide plate with a first protrusion and a second protrusion, the first protrusion having a hole; a locking button having a locking button base; an upper catch having a nib; and a power supply connector; wherein the slide plate is mounted slidably between the main base and the cover; the locking button is mounted slidably within the holder cavity; the locking button base corresponds in shape to the hole; the power supply connector is connected to the slide; and the second protrusion is adapted to engage the nib, whereby when the phone is inserted and locked in the holder cavity, the upper catch is locked and the slide and the power supply connector are in their protruding position.

### CROSS-REFERENCE TO RELATED APPLICATIONS

Pursuant to 35 U.S.C. §119 and the Paris Convention Treaty, this application claims the benefit of European Patent Application No. EP08460035 filed Aug. 21, 2008, the contents of which are incorporated herein by reference in their entirety.

### BACKGROUND OF THE INVENTION

1. Field of the Invention

This invention relates to a mobile phone holder with lateral power supply, especially for a mechanical vehicle.

2. Description of the Related Art

Recently, mobile phones with contacts located on lateral wall have become more widespread. The increasing use of such phones can be justified by the need to increase the distance between the power supply connection and the phone antenna, which is usually located at the top wall or the bottom wall of the phone, and thus to reduce interference of the signal received by the antenna. Placing contacts on the lateral wall of the phone has a significant influence on the design of mobile phone holders, since—in order to avoid damaging the contacts of the phone when the phone is inserted into the holder—the contacts of the holder cannot have a fixed location but have to be extended after the phone is seated in the holder.

U.S. Pat. No. 5,708,707 recites a mobile phone holder, in which the bottom wall of the holder cavity into which the phone is seated is mounted slidably in the cover. When the phone is inserted into the holder the contacts move downwards and interlock with a fixed contact located in the bottom wall of the cover.

European Pat. No. 1055562 recites a mobile phone holder provided in its lower part with a slide, which slides along the axis of the phone in guides located in the cover of the phone and which is provided with a contact that moves into the slot in the mobile phone if the slide is manually moved upwards.

### SUMMARY OF THE INVENTION

In order to protect the contact in the slide from being damaged it is necessary to provide the bottom wall of the phone with a rounded shape and the top wall of the slide with a shape, which is the negative reflection of the wall of the phone. This design also prevents the phone from being inserted into the holder when the slide is moved away and the contact from being damaged.

Thus, one objective of this invention is to provide a mobile phone holder with a lateral power supply, especially for mechanical vehicles, wherein a contact of the holder is adapted to engage with a lateral connection of the mobile phone without a risk of damaging this contact when the phone is inserted into the holder.

This objective is achieved by providing a holder for a mobile phone, comprising: a main base; a cover with a holder cavity; a slide comprising a slide plate with a first protrusion and a second protrusion, the first protrusion having a hole; a locking button having a locking button base; an upper catch having a nib; and a power supply connector; wherein the slide plate is mounted slidably between the main base and the cover; the locking button is mounted slidably within the holder cavity; the locking button base corresponds in shape to the hole; the power supply connector is connected to the slide; and the second protrusion is adapted to engage the nib, whereby when the phone is inserted and locked in the holder cavity, the upper catch is locked and the slide and the power supply connector are in their protruding position.

In one class of this embodiment, the slide plate is a flat, rectangular plate provided, on its one side, with a second button connected to the power supply connector, as well as, on the other side, with a third button for retracting the power supply connector; and the slide plate is connected to the first protrusion.

In another class of this embodiment, the power supply connector is disposed within the second button, and a power supply plug protrudes from the second button and has a length adapted to provide additional support to hold the phone in the holder cavity.

In yet another class of this embodiment, the holder comprises further a shield with projections; the cover comprises a first notch and the base comprises a second notch, the slide plate is mounted slidably in the first notch and the second notch, and the slide plate comprises guides, the guides being adapted to engage with the projections.

### BRIEF DESCRIPTION OF THE DRAWINGS

The mobile phone holder, according to the invention, is presented, by way of the example only, in the drawings, in which:

FIG. 1 is a perspective front view of a mobile phone holder according to a representative embodiment of the invention, with a mobile phone seated in the holder, with power supply contacts in their retracted position;

FIG. 2 is another perspective view thereof according to a representative embodiment of the invention, with a mobile phone removed from the holder, showing power supply contacts in their retracted position;

FIG. 3 is another perspective view thereof according to a representative embodiment of the invention, with a mobile phone removed from the holder, showing power supply contacts in their protruding position;

FIG. 4 is an exploded view of the holder according to a representative embodiment of the invention;

FIG. 5 is a partial front view of the holder according to a representative embodiment of the invention, with the cover removed, showing power supply contacts in their retracted position; and

FIG. 6 is a partial front view of the holder according to a representative embodiment of the invention, with the cover removed, showing power supply contacts in their protruding position.

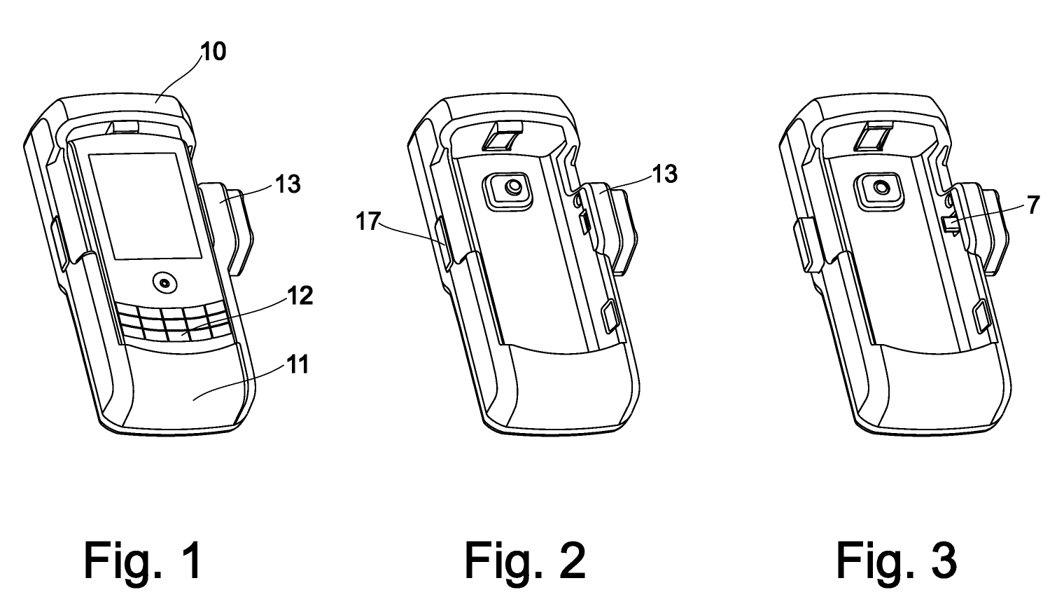

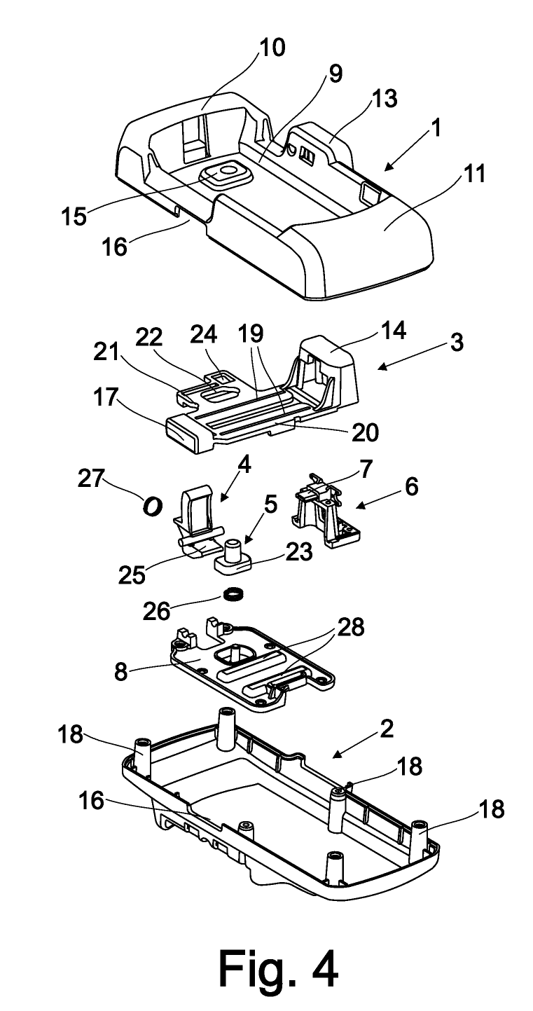

### DETAILED DESCRIPTION OF THE EMBODIMENTS

Detailed description will be given below with reference to accompanying drawings.

The mobile phone holder with a lateral power supply connector, especially for mechanical vehicles, according to the invention, as depicted in the drawing, comprises: a cover 1, a main base 2, a slide 3, an upper catch 4, a locking button 5, which prevents a slide 3 from being moved, and a casing 8 (shield of the slide) enclosing the mechanism of the slide 3 at its bottom. The elements of the holder are enclosed between the cover 1 and the main base 2.

The slide 3 is also provided with a power supply connector 6, which has an electronic circuit board, not depicted on the drawing, and a plug 7 protruding from this connector. The cover 1 has a shape of a cubicoid provided with a cavity 9 to accommodate a mobile phone, with an upper protrusion 10 and a lower protrusion 11 to protect the mobile phone 12 seated in the holder cavity 9 from being moved and with a shielding protrusion 13, which shields and guides the button 14 of the slide 3.

The cover 1 is also provided in the lower part of the cavity 9 with a flat protrusion 15 with a hole, through which the locking button 5 is adapted to pass through; the protrusion 15 is an adapted surface of the cavity 9, adapted to the model of a mobile phone. Moreover, on the side opposite to the protrusion 13, the cover 1 is provided with a notch 16, which is adapted to serve as a guide for a button 17, which protrudes from the other side of the slide 3. A similar notch 16, which is adapted to serve as the other guide of the slide 3, is provided in the main base 2.

The main base 2, which has a shape of a rectangular plate, is provided at its edge with protrusions 18 with holes, through which the screws that mount the main base 2 to the cover 1 are driven. The shape of the lower part of the base is adapted to a hanger fixed to a proper element of a mechanical vehicle. The slide 3 has a shape of a rectangular plate 20, provided with guides 19, mounted slidably on transverse protrusions of the lower part of the cover 1 (the protrusions are not shown on the drawing). The plate 20 is provided on its one side with a protrusion 21 with a hole 22 that is adapted to engage with a locking button base 23 of the locking button 5. The locking button 5 has a shape that corresponds to the protrusion 21. The protrusion 21 of the plate 20 is also provided with an additional blocking protrusion 24, which is adapted to engage with the lower nib 25 of the catch 4.

Both the locking button 5 and the upper catch 4 are provided with springs 26 and 27, respectively.

The power supply connector 6 is provided within the button 14 of the slide 3 but the plug 7 protrudes outside the button 14. The slide 3, the upper catch 4 and the locking button 5 are mounted within the cover 1 and are enclosed at the bottom with a shield 8. The shield 8 has a shape of a plate, which has projections 28 on the surface facing the slide 3, which slides along these projections.

The entire cover 1 is enclosed at the bottom with the main base 2 mounted to it.

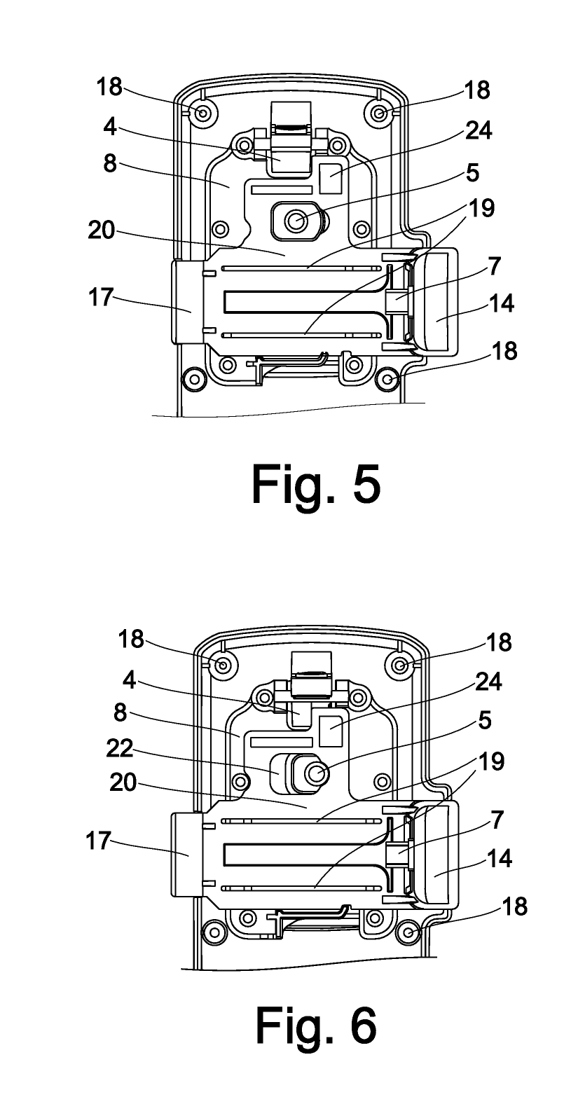

The mobile phone holder with a lateral power supply connector, as described above, operates as follows: in its initial position, prior to the mobile phone being seated in the holder, the slide 3 stays in its rightmost position, whereas the locking button 5 is pulled upwards by the spring 26. The locking button base 23 of the locking button 5 is in the hole 22 of the protrusion 21 of the plate 20 of the slide 3 (FIG. 5). In the position of the locking button 5 as protruding from the lower surface of the cavity 9, the slide 3 is blocked and protected against an accidental move. As the mobile phone 12 is seated into the cavity 9 of the holder, its rear wall presses the locking button 5 and the upper catch 4 concurrently, which results in the catch 4 moving upwards.

When the locking button 5 is pressed, the locking button base 23 overcomes the force of the spring 26 and leaves the hole 22 in the plate 20. The slide 3 is unlocked and its transverse move is now possible. At the same time the spring 27 presses the upper catch 4 thus making it move downwards and catch the mobile phone 12 seating in the cavity 9. In order to guide the power supply connector 6 into a proper slot of the mobile phone, the button 14 is pressed, which moves the slide 3 leftwards. In the leftmost position of the slide 3, its protrusion 24 goes under the lower nib of the upper catch 4, thus blocking its move and locking the phone in the holder.

In this arrangement, moving the slide 3 results in a concurrent turning on of the phone and protecting it from dropping out of the cavity 9.

In a protruding position, the plug 7 of the power supply connector 6 has an appropriate length to provide an additional support to hold the phone seated in the cavity 9 of the holder.

In order to remove the mobile phone 12 from the holder, it is necessary to move the slide 3 first into its rightmost position, i.e., press the button 17, which results in a move of the plug 7 off the power supply slot of the phone and a concurrent unlocking the catch 4 by the protrusion 24 of the plate 20. The mobile phone can be then removed from the cavity 9 without any damage to the plug 7. Once the phone is removed, the button 5 returns to its initial position under the force of the spring 26 and again blocks the slide 3. This position protects the plug 7 from being unintentionally pushed out from the shielding protrusion 13 and being damaged by an improper attempt to place the mobile phone 12 in the holder.

This invention is not to be limited to the specific embodiments disclosed herein and modifications for various applications and other embodiments are intended to be included within the scope of the appended claims. While this invention has been described in connection with particular examples thereof, the true scope of the invention is not so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A holder for a mobile phone, comprising:
a main base;
a cover with a holder cavity;
a slide comprising a slide plate with a first protrusion and a second protrusion, said first protrusion having a hole;
a locking button having a locking button base;
an upper catch having a nib; and
a power supply connector;
wherein
said slide plate is mounted slidably between said main base and said cover;
said locking button is mounted slidably within said holder cavity;
said locking button base corresponds in shape to said hole;
said power supply connector is connected to said slide; and
said second protrusion is adapted to engage said nib, whereby when the phone is inserted and locked in the holder cavity, said upper catch is locked and the slide and the power supply connector are in their protruding position.

2. The holder of claim 1, wherein said slide plate is a flat, rectangular plate provided, on its one side, with a second button connected to said power supply connector, as well as, on the other side, with a third button for retracting the power supply connector; and said slide plate is connected to said first protrusion.

3. The holder of claim 1, wherein said power supply connector is disposed within said second button, and a power supply plug protrudes from said second button and has a length adapted to provide additional support to hold the phone in the holder cavity.

4. The holder of claim 2, wherein said power supply connector is disposed within said second button, and a power supply plug protrudes from said second button and has a length adapted to provide additional support to hold the phone in the holder cavity.

5. The holder of claim 1, comprising further a shield with projections, wherein said cover comprises a first notch and said base comprises a second notch, said slide plate is mounted slidably in said first notch and said second notch, and said slide plate comprises guides, said guides being adapted to engage with said projections.

6. The holder of claim 2, comprising further a shield with projections, wherein said cover comprises a first notch and said base comprises a second notch, said slide plate is mounted slidably in said first notch and said second notch, and said slide plate comprises guides, said guides being adapted to engage with said projections.

7. The holder of claim 3, comprising further a shield with projections, wherein said cover comprises a first notch and said base comprises a second notch, said slide plate is mounted slidably in said first notch and said second notch, and said slide plate comprises guides, said guides being adapted to engage with said projections.

8. The holder of claim 4, comprising further a shield with projections, wherein said cover comprises a first notch and said base comprises a second notch, said slide plate is mounted slidably in said first notch and said second notch, and said slide plate comprises guides, said guides being adapted to engage with said projections.
